(19) United States
(12) Patent Application Publication
(10) Pub. No.: US 2010/0080127 A1
(43) Pub. Date: Apr. 1, 2010

(54) INTERCEPTION METHOD AND DEVICE THEREOF

(76) Inventors: Yu YIN, Shenzhen (CN); Jin Zhang, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/630,977

(22) Filed: Dec. 4, 2009

Related U.S. Application Data
(63) Continuation of application No. PCT/CN2008/070970, filed on May 15, 2008.

(30) Foreign Application Priority Data
Jun. 8, 2007 (CN) 200710110905.4
Aug. 10, 2007 (CN) 200710135749.7

(51) Int. Cl. H04J 1/16; G06F 15/16; H04L 12/56

(52) U.S. Cl. 370/235; 709/235; 370/401

(57) ABSTRACT

An interception method and an interception device are provided. The interception method includes the following steps. An interception center assigns an interception task to an interception network element (NE) to request to intercept an interception target. The interception NE reports user plane data of corresponding service sessions of the interception target satisfying an interception reporting policy according to the received interception task and the configured interception reporting policy.

### CROSS-REFERENCE TO RELATED APPLICATIONS

This application is a continuation of International Patent Application No. PCT/CN2008/070970, filed on May 15, 2008, which claims priority to Chinese Patent Application No. 200710110905.4, filed on Jun. 8, 2007, and Chinese Patent Application No. 200710135749.7, filed on Aug. 10, 2007, all of which are hereby incorporated by reference in their entireties.

### FIELD OF THE TECHNOLOGY

The present disclosure relates to the field of mobile communication technologies, and more particularly to an interception method and an interception device.

### TECHNICAL BACKGROUND

Lawful interception refers to a mechanism for intercepting a communication system or activities of intercepted users in specific applications in the communication system by state security organizations, for example, security bureaus and police bureaus under a legal authorization. For ease of description, in the present disclosure, the lawful interception is called interception for short.

An interception network is usually formed by an interception center, an interception gateway, and an interception network element (interception NE). The interception NE refers to a communication device that provides services for users, for example, a program control switch in a fixed communication network, a mobile switching center server of a circuit switched domain in a mobile communication network, and a serving general packet radio service (GPRS) supporting node of a packet switched domain. The interception center is an entity for the state security organs to deliver interception commands and receive information about interception targets reported by the network device. The interception gateway is introduced between the interception center and the interception NE, which aims to be adapting and shielding the interception interface difference between the interception center and the interception NE, thereby simplifying the implementation of the interception center and the interception NE.

The information about the interception targets focused by the interception center is divided into two types. One type is control messages, including signaling messages in the process of registering, moving, setting up or releasing sessions of target users in the network. The other type is user plane data, which is transmitted in the service sessions when the target users use the communication services, for example, voice data flows transmitted when the user is making a phone call, and data packets and faxes transmitted between the user and an E-mail server, or the user and a network server when the user accesses the network, and the like.

Usually, a specific process of the interception is as follows.

The interception center delivers an interception task message to the interception gateway, in which the message includes identifiers of interception targets, types of the reported interception data, and so on. The interception gateway forwards the interception task message to the corresponding interception NE. When signaling activities of the interception targets trigger a specified event, the interception NE reports a corresponding control message to the interception gateway, and the interception gateway reports the corresponding control message to the interception center. When the interception targets transmit the user plane data, if the interception gateway requests the interception NE to report the user plane data of the targets, the interception NE reports the user plane data of the interception targets to the interception gateway, and the interception gateway reports the user plane data of the targets to the interception center.

In the early circuit switched network, bandwidths occupied by the users when performing services are rather small, that is, the bandwidth occupied by a single user is quite small, and the total bandwidth required is also not large, and thus, even if the interception NE is requested to report the user plane data of the interception targets that transmit the user plane data, the interception NE does not have heavy performance and cost burdens.

However, as the packet switched network emerges and has developed rapidly, the single user accessing bandwidth provided by the packet switched network becomes increasingly higher, and the interception NE is requested to report the user plane data of the interception targets, so that the flow of the reported interception user plane data that needs to be supported by the interception NE becomes increasingly larger accordingly. Meanwhile, due to the special requirements on the completeness and security of the data during the interception, the interception NE has a large processing overhead when reporting the user plane data, so that a design cost of the interception NE is increased. Furthermore, if the flow of the reported interception user plane data is rather large, additional high cost is brought to the operator, and the interception fee to be paid is also rather high, thereby further increasing a running cost of using the interception function by the state security organs.

### SUMMARY

Accordingly, the present disclosure is directed to an interception method and an interception device thereof, which are capable of lowering the flow of user plane data reported during an interception process.

An embodiment of the present disclosure provides an interception method, which includes the following steps.

An interception network element (NE) receives an interception task intercepting an interception target.

The interception NE reports user plane data of a corresponding service session of the interception target satisfying an interception reporting policy according to the received interception task and the interception reporting policy.

An embodiment of the present disclosure also provides a packet data gateway, which includes a receiving unit, a classifying unit, an adding unit, and a sending unit.

The receiving unit is configured to receive user plane data sent from an interception target or to be forwarded to the interception target.

The classifying unit is configured to classify the user plane data received by the receiving unit based on traffic flows according to service feature information.

The adding unit is configured to add a service associated identifier to the user plane data classified by the classifying unit, in which the service associated identifier is configured to identify the traffic flow of the user plane data.

The sending unit is configured to report the user plane data with the service associated identifier added by the adding unit.

An embodiment of the present disclosure further provides an interception center, which includes a receiving unit and an analyzing unit.

The receiving unit is configured to receive user plane data added with a service associated identifier.

The analyzing unit is configured to select service feature information corresponding to the service associated identifier according to the service associated identifier of the user plane data received by the receiving unit, and analyze and restore the user plane data.

An embodiment of the present disclosure further provides an interception NE, which is configured to report user plane data of an interception target, and includes a receiving unit, an interception reporting policy unit, and a sending unit.

The receiving unit is configured to receive an interception task intercepting an interception target.

The interception reporting policy unit is configured to store interception reporting policy.

The sending unit is configured to report user plane data of corresponding service sessions of the interception target satisfying the interception reporting policy according to the interception reporting policy in the interception reporting policy unit.

Through the interception method and the interception device thereof according to the embodiments of the present disclosure, according to the interception reporting policy, the user plane data of the corresponding service sessions of the interception targets is reported to the interception center, so as to guarantee the reporting of user plane data of interception targets with high interception priorities or significant service sessions, and reduce the flow of the reported user plane data of some insignificant interception targets or insignificant service sessions. Therefore, it is ensured that the user plane data of significant interception targets or significant service sessions can be reported to the interception center at high priorities, thereby lowering design cost and running cost of an interception system.

### BRIEF DESCRIPTION OF THE DRAWINGS

FIG. 1 is a flow chart of an interception method according to a first embodiment of the present disclosure;

FIG. 2 is a flow chart of an interception method according to a second embodiment of the present disclosure;

FIG. 3 is a flow chart of an method according to a third embodiment of the present disclosure;

FIG. 4 is a flow chart of an interception method according to a fourth embodiment of the present disclosure;

FIG. 5 is a flow chart of an interception method according to a fifth embodiment of the present disclosure;

FIG. 6 is a flow chart of an interception method according to a sixth embodiment of the present disclosure;

FIG. 7 is a flow chart of an interception method according to a seventh embodiment of the present disclosure;

FIG. 8 is a structural view of an interception system according to an embodiment of the present disclosure;

FIG. 9 is a structural view of an interception NE according to an embodiment of the present disclosure;

FIG. 10 is a flow chart of an interception method according to an eighth embodiment of the present disclosure;

FIG. 11 is a schematic principle view of an interception system according to another embodiment of the present disclosure; and

FIG. 12 is a structural view of an interception system according to still another embodiment of the present disclosure.

### DETAILED DESCRIPTION OF THE EMBODIMENTS

Embodiments of the present disclosure are further described in detail in the following with reference to the accompanying drawings.

In an embodiment, the present disclosure provides an interception method, which includes the following steps. An interception NE receives an interception task to intercept interception targets. The interception NE reports user plane data of corresponding service sessions of the interception targets satisfying the interception reporting policy according to the received interception task and the configured interception reporting policy.

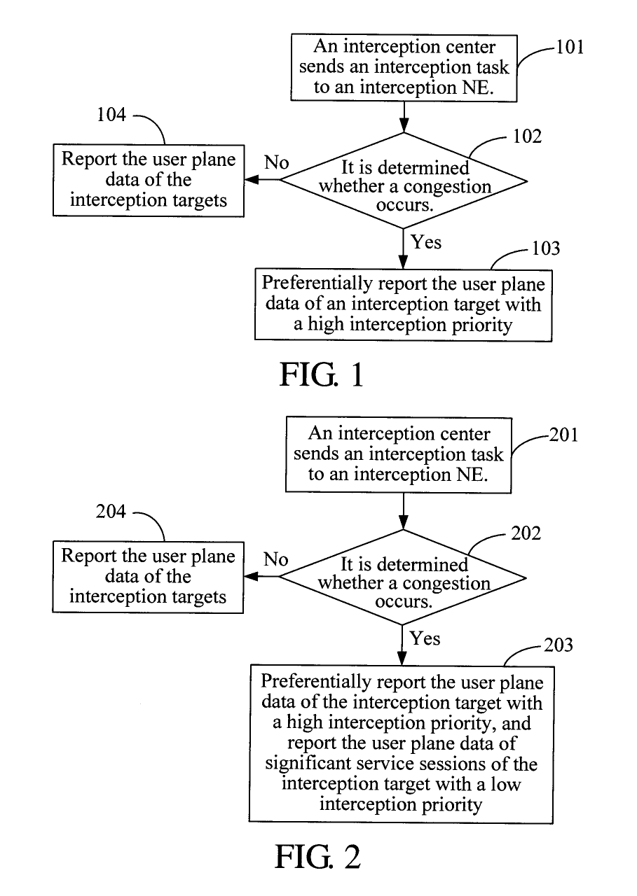

FIG. 1 is a flow chart of an interception method according to a first embodiment of the present disclosure. Referring to FIG. 1, in this embodiment, the interception reporting policy includes: interception priorities of interception targets are designated, and when congestion occurs in an interception reporting path, an interception NE reports the user plane data of an interception target with a high interception priority. The interception reporting policy associated with the interception targets is configured, which included in the interception task received by the interception NE.

A specific exemplary process of the interception includes the following steps.

In step 101, an interception center assigns an interception task to an interception NE, requesting the interception NE to intercept interception targets, user A and user B, and designating interception priorities of the interception targets.

For example, the interception priority of the interception target user A is designated to be a high priority, and the interception priority of user B is designated to be a low priority.

The interception center may assign the interception task to the interception NE in the following exemplary manners.

In a first exemplary manner, the interception center directly assigns the interception task to the interception NE, requesting the interception NE to intercept the target users A and B.

In a second exemplary manner, the interception center assigns the interception task of intercepting the target users A and B to an interception gateway; after receiving the interception task sent from the interception center, the interception gateway forwards the interception task to the interception NE.

In step 102, it is determined whether congestion occurs in an interception reporting path, and if yes, the process proceeds to step 103; otherwise, the process proceeds to step 104.

For example, it is determined whether congestion occurs on a reporting interface between the interception NE and the interception center, or on a reporting interface between the interception NE and the interception gateway, or on a reporting interface between the interception gateway and the interception center.

In step 103, the interception NE preferentially reports the user plane data of user A with the high interception priority according to the designated interception priorities of the interception targets.

In step 104, the interception NE reports the user plane data of user A and user B to the interception center.

The interception NE may report the user plane data to the interception center in the following exemplary manners.

In a first exemplary manner, the interception NE directly reports the user plane data to the interception center.

In a second exemplary manner, the interception NE reports the user plane data to the interception gateway; after receiving the user plane data reported by the interception NE, the interception gateway forwards the user plane data to the interception center.

FIG. 2 is a flow chart of an interception method according to a second embodiment of the present disclosure. Referring to FIG. 2, in this embodiment, the interception reporting policy includes: interception priorities of interception targets are designated and interception significance levels of different types of service sessions are configured, and when congestion occurs in an interception reporting path, an interception NE preferentially reports the user plane data of the interception target with a high interception priority, and the user plane data of a high-significance-level service session of an interception target with a low interception priority.

The interception reporting policy associated with the interception targets is configured, which included in the interception task received by the interception NE.

The interception significance levels of different types of service sessions may be configured in the following exemplary manners.

In a first exemplary manner, an interception center delivers configuration policy for the interception significance levels of different types of service sessions to the interception NE in advance.

In a second exemplary manner, the interception significance levels of different types of service sessions are directly configured on the interception NE in advance.

For example, the interception significance of a voice service is designated as the highest level, the interception significance of a short message service is designated as a lower level, and the interception significances of the other services are designated as the lowest levels.

A specific exemplary process of the interception includes the following steps.

In step 201, the interception center assigns an interception task to the interception NE, requesting the interception NE to intercept interception targets, user A and user B, and designating interception priorities of the interception targets.

For example, the interception priority of the interception target user A is designated to be a high priority, and the interception priority of user B is designated to be a low priority.

The interception center may assign the interception task to the interception NE in the following exemplary manners.

In a first exemplary manner, the interception center directly assigns the interception task of intercepting the target users A and B to the interception NE.

In a second exemplary manner, the interception center assigns the interception task of intercepting the target users A and B to an interception gateway; after receiving the interception task sent from the interception center, the interception gateway forwards the interception task to the interception NE.

In step 202, it is determined whether congestion occurs in an interception reporting path, and if yes, the process proceeds to step 203; otherwise, the process proceeds to step 204.

In step 203, the interception NE preferentially reports the user plane data of user A with the high interception priority, and reports the user plane data of significant service sessions of user B with the low interception priority, for example, the voice service and the short message service.

In step 204, the interception NE reports the user plane data of user A and user B to the interception center.

The interception NE may report the user plane data to the interception center in the following exemplary manners.

In a first exemplary manner, the interception NE directly reports the user plane data to the interception center.

In a second exemplary manner, the interception NE reports the user plane data to the interception gateway; after receiving the user plane data reported by the interception NE, the interception gateway forwards the user plane data to the interception center.

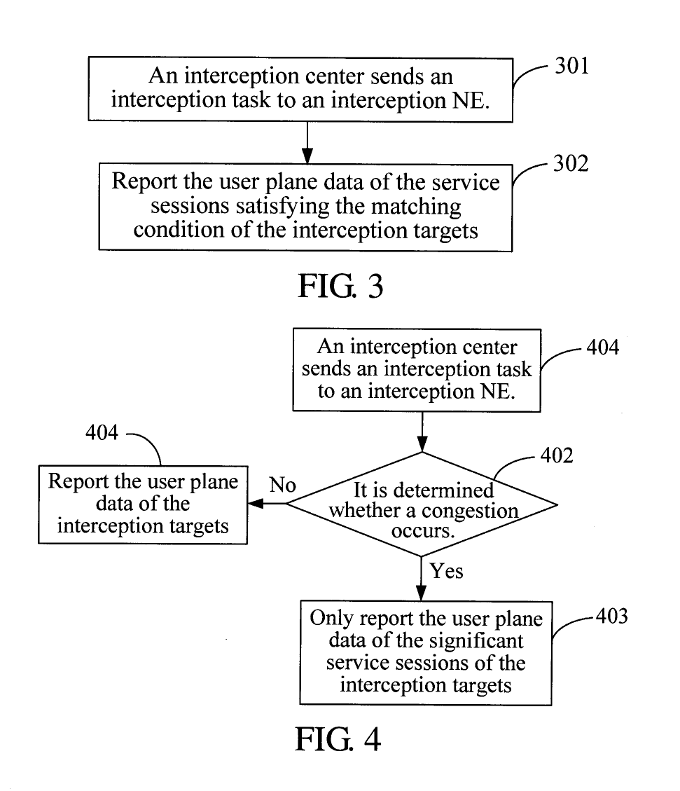

FIG. 3 is a flow chart of an interception method according to a third embodiment of the present disclosure. Referring to FIG. 3, in this embodiment, the interception reporting policy includes: an interception center designates matching condition for service sessions of an interception target, and an interception NE reports the user plane data of the service sessions satisfying the matching condition. The interception reporting policy associated with the interception targets is configured, which included in the interception task received by the interception NE.

A specific process of the interception includes the following steps.

In step 301, the interception center assigns an interception task to the interception NE, requesting the interception NE to intercept interception targets, user A and user B, and designating matching condition for service sessions of each interception target.

For example, it is designated that the interception NE reports the user plane data of a voice service and an Internet service of user A, and the interception NE reports the user plane data of a voice service and a video telephony service of user B.

The interception center may assign the interception task to the interception NE in the following exemplary manners.

In a first exemplary manner, the interception center directly assigns the interception task of intercepting the target users A and B to the interception NE.

In a second exemplary manner, the interception center assigns the interception task of intercepting the target users A and B to an interception gateway; after receiving the interception task sent from the interception center, the interception gateway forwards the interception task to the interception NE.

In step 302, the interception NE reports the user plane data of service sessions satisfying the matching condition of each interception target.

For example, the interception NE reports the user plane data of the voice service and Internet service sessions of user A, and the interception NE reports the user plane data of the voice service and video telephony service sessions of user B.

The interception NE may report the user plane data to the interception center in the following exemplary manners.

In a first exemplary manner, the interception NE directly reports the user plane data to the interception center.

In a second exemplary manner, the interception NE reports the user plane data to the interception gateway; after receiving the user plane data reported by the interception NE, the interception gateway forwards the user plane data to the interception center.

FIG. 4 is a flow chart of an interception method according to a fourth embodiment of the present disclosure. Referring to FIG. 4, in this embodiment, the interception reporting policy includes: interception significance levels for different types of service sessions are configured, and when congestion occurs in an interception reporting path, an interception NE preferentially reports the user plane data of service sessions with a high significance level of an interception target.

The interception significance levels for different types of service sessions may be configured in the following manners.

In a first manner, an interception center delivers a configuration policy for the interception significance levels of different types of service sessions to the interception NE in advance.

In a second manner, the interception significance levels of different types of service sessions are directly configured on the interception NE in advance.

For example, the interception significance of a voice service is configured as the highest level, the interception significance of a video telephony service is configured as a lower level, and the interception significances of the other services are configured as the lowest level.

A specific process of the interception includes the following steps.

In step 401, the interception center assigns an interception task to the interception NE, requesting the interception NE to intercept interception targets, that is, user A and user B.

The interception center may assign the interception task to the interception NE in the following exemplary manners.

In a first exemplary manner, the interception center directly assigns the interception task of intercepting the target users A and B to the interception NE.

In a second exemplary manner, the interception center assigns the interception task of intercepting the target users A and B to an interception gateway; after receiving the interception task sent from the interception center, the interception gateway forwards the interception task to the interception NE.

In step 402, it is determined whether congestion occurs in an interception reporting path, and if yes, the process proceeds to step 403; the process proceeds to step 404.

In step 403, the interception NE preferentially reports the user plane data of the voice service and the video telephony service of user A and user B according to the configured interception significance levels of different types of service sessions.

In step 404, the interception NE reports the user plane data of user A and user B to the interception center.

The interception NE may report the user plane data to the interception center in the following exemplary manners.

In a first exemplary manner, the interception NE directly reports the user plane data to the interception center.

In a second exemplary manner, the interception NE reports the user plane data to the interception gateway; after receiving the user plane data reported by the interception NE, the interception gateway forwards the user plane data to the interception center.

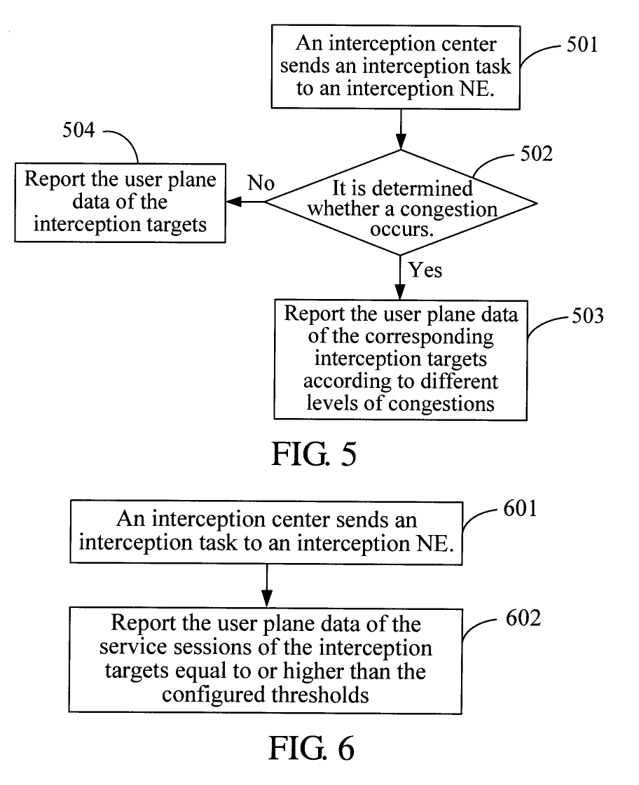

FIG. 5 is a flow chart of an interception method according to a fifth embodiment of the present disclosure. Referring to FIG. 5, in this embodiment, the interception reporting policy includes: priorities for interception targets are designated, interception significance levels for different types of service sessions are configured, and reporting policies of the user plane data of interception targets with different priorities for different levels of congestions are configured; when congestion occurs in an interception reporting path, an interception NE reports the user plane data of corresponding service sessions of the interception targets according to the reporting policies of the user plane data of the interception targets with different interception priorities configured for different levels of congestions.

The interception reporting policy associated with the interception targets is configured, which included in the interception task received by the interception NE.

The interception significance levels for different types of service sessions and the reporting policies of the user plane data of interception targets with different priorities for different levels of congestions at the interception interfaces may be configured in the following exemplary manners.

In a first exemplary manner, an interception center delivers configuration policy of the interception significance levels of different types of service sessions and the reporting policies of the user plane data of interception targets with different priorities to the interception NE in advance.

In a second exemplary manner, the interception significance levels of different types of service sessions and the reporting policies of the user plane data of interception targets with different priorities are directly configured on the interception NE in advance.

For example, the interception significance of a voice service is designated as the highest level, the interception significance of a video telephony service is designated as a lower level, and the interception significances of the other services are designated as the lowest level. It is configured that when an interception congestion level is higher, the interception NE reports the user plane data of the voice service and the video telephony service of a user with a high priority, and does not report user plane data of a user with a low priority; when the interception congestion level is lower, the interception NE reports the user plane data of all types of service sessions of the user with the high priority, and only reports the user plane data of the voice service of the user with the low priority.

A specific process of the interception includes the following steps.

In step 501, the interception center assigns an interception task to the interception NE, requesting the interception NE to intercept interception targets, i.e., user A and user B, and designating interception priorities for the interception targets.

For example, the interception priority of the interception target user A is designated to be a high priority, and the interception priority of user B is designated to be a low priority.

The interception center may assign the interception task to the interception NE in the following exemplary manners.

In a first exemplary manner, the interception center directly assigns the interception task of intercepting the target users A and B to the interception NE.

In a second exemplary manner, the interception center assigns the interception task of intercepting the target users A and B to an interception gateway; after receiving the interception task sent from the interception center, the interception gateway forwards the interception task to the interception NE.

In step 502, it is determined whether congestion occurs in an interception reporting path, and if yes, the process proceeds to step 503; otherwise, the process proceeds to step 504.

In step 503, the interception NE reports the user plane data of corresponding service sessions of the interception targets according to the configured reporting policies of the user plane data of the interception targets with different interception priorities for different levels of congestions.

For example, when an interception congestion level is higher, the interception NE reports the user plane data of the voice service and the video telephony service of user A, and does not report any user plane data of user B. When the interception congestion level is lower, the interception NE reports the user plane data of all types of service sessions of user A, and only reports the user plane data of the voice service of user B.

In step 504, the interception NE reports the user plane data of user A and user B to the interception center.

The interception NE may report the user plane data to the interception center in the following exemplary manners.

In a first exemplary manner, the interception NE directly reports the user plane data to the interception center.

In a second exemplary manner, the interception NE reports the user plane data to the interception gateway; after receiving the user plane data reported by the interception NE, the interception gateway forwards the user plane data to the interception center.

FIG. 6 is a flow chart of an interception method according to a sixth embodiment of the present disclosure. Referring to FIG. 6, in this embodiment, the interception reporting policy includes: priorities for interception targets are designated, interception significance levels for different types of service sessions are configured, and report thresholds for the interception targets with different priorities are configured, in which an interception NE reports the user plane data of service sessions of the interception targets equal to or higher than the corresponding thresholds.

The interception reporting policy associated with the interception targets is configured, which included in the interception task received by the interception NE.

The interception significance levels for different types of service sessions and the report thresholds for the interception targets with different priorities may be configured in the following exemplary manners.

In a first exemplary manner, an interception center delivers configuration policy for the interception significance levels of different types of service sessions and the report thresholds of the interception targets with different priorities to the interception NE in advance.

In a second exemplary manner, the interception significance levels of different types of service sessions and the report thresholds of the interception targets with different priorities are directly configured on the interception NE in advance.

For example, the interception significance of a voice service is configured as the highest level, the interception significance of a video telephony service is configured as a lower level, the interception significance of a wireless application protocol (WAP) service is configured as an even lower level, and the interception significances of the other services are configured as the lowest level. The report threshold of the interception target with the high interception priority is designated to be the WAP, and the report threshold of the interception target with the low interception priority is designated to be the video telephony service.

A specific process of the interception includes the following steps.

In step 601, the interception center assigns an interception task to the interception NE, requesting the interception NE to intercept interception targets, that is, user A and user B, and designating priorities for the interception targets.

For example, the interception priority of the interception target user A is designated to be a high priority, and the interception priority of user B is designated to be a low priority.

The interception center may assign the interception task to the interception NE in the following exemplary manners.

In a first exemplary manner, the interception center directly assigns the interception task of intercepting the target users A and B to the interception NE.

In a second exemplary manner, the interception center assigns the interception task of intercepting the target users A and B to an interception gateway; after receiving the interception task sent from the interception center, the interception gateway forwards the interception task to the interception NE.

In step 602, the interception NE reports the user plane data of service sessions of the interception targets equal to or higher than the configured thresholds.

For example, the interception NE reports the user plane data of the voice, video telephony, and WAP services of user A, and reports the user plane data of the voice and video telephony services of user B.

The interception NE may report the user plane data to the interception center in the following exemplary manners.

In a first exemplary manner, the interception NE directly reports the user plane data to the interception center.

In a second exemplary manner, the interception NE reports the user plane data to the interception gateway; after receiving the user plane data reported by the interception NE, the interception gateway forwards the user plane data to the interception center.

Through the interception method according to the embodiments of the present disclosure, according to the interception reporting policy, the user plane data of corresponding service sessions of the interception targets satisfying the interception reporting policy is reported to the interception center, so as to reduce the reporting flow of the user plane data of some insignificant interception targets or insignificant service sessions, thereby lowering a design cost and a running cost of an interception system.

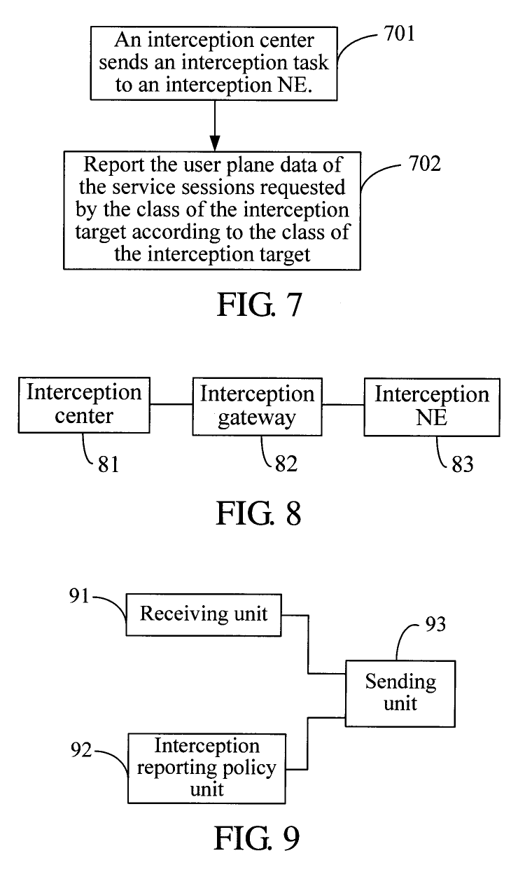

FIG. 7 is a flow chart of an interception method according to a seventh embodiment of the present disclosure. Referring to FIG. 7, in this embodiment, the interception reporting policy includes: classes of interception targets, and a service session type for being reported to an interception center for a class of the interception target, in which an interception NE only reports the user plane data of the service session type requested by the class of the interception target according to the class of the interception target.

The interception reporting policy associated with the interception targets is configured, which included in the interception task received by the interception NE.

The service session type for being reported to the interception center may be configured for each class of the interception target in the following exemplary manners.

In a first exemplary manner, the interception center delivers the service session type for being reported to the interception center for each class of the interception target to the interception NE in advance.

In a second exemplary manner, the service session type for being reported to the interception center for each class of the interception target is directly configured on the interception NE in advance.

For example, the user plane data of a voice service of the interception target is designated as a first class that needs to be reported, and the user plane data of a video telephony service of the interception target is designated as a second class that needs to be reported.

A specific process of the interception includes the following steps.

In step 701, the interception center assigns an interception task to the interception NE, requesting the interception NE to intercept interception targets, i.e., user A and user B, and designating classes of the interception targets.

For example, the interception class of the interception target user A is designated as the first class, and the interception class of user B is designated as the second class.

When delivering the interception targets, the interception center also delivers indices of the classes of the interception targets to designate the classes of the interception targets.

The interception center may assign the interception task to the interception NE in the following manners.

In a first manner, the interception center directly assigns the interception task of intercepting the target users A and B to the interception NE.

In a second manner, the interception center assigns the interception task of intercepting the target users A and B to an interception gateway; after receiving the interception task sent from the interception center, the interception gateway forwards the interception task to the interception NE.

In step 702, the interception NE reports the user plane data corresponding to the interception targets.

For example, the interception NE reports the user plane data of the voice service of user A, and reports the user plane data of the video telephony service of user B.

The interception NE may report the user plane data to the interception center in the following manners.

In a first manner, the interception NE directly reports the user plane data to the interception center.

In a second manner, the interception NE reports the user plane data to the interception gateway; after receiving the user plane data reported by the interception NE, the interception gateway forwards the user plane data to the interception center.

FIG. 8 is a structural view of an interception system according to an embodiment of the present disclosure. Referring to FIG. 8, the interception system includes an interception center 81, an interception gateway 82, and an interception NE 83.

The interception center 81 is configured to send an interception task of intercepting interception targets. The interception NE 83 is configured to report user plane data of corresponding service sessions of the interception targets satisfying the configured interception reporting policy to the interception center 81, according to the received interception task and the interception reporting policy. The interception gateway 82 is configured to receive the interception task of intercepting the interception targets sent from the interception center 81 and forward the interception task to the interception NE 83, and is configured to receive the user plane data of the corresponding service sessions of the interception targets reported by the interception NE 83 and forward the user plane data to the interception center 81.

FIG. 9 is a structural view of an interception NE according to an embodiment of the present disclosure. Referring to FIG. 9, the interception NE includes a receiving unit 91, an interception reporting policy unit 92, and a sending unit 93.

The receiving unit 91 is configured to receive an interception task of intercepting an interception target. The interception reporting policy unit 92 is configured to store an interception reporting policy. The sending unit 93 is configured to report user plane data of corresponding service sessions of the interception target satisfying the interception reporting policy according to the interception reporting policy in the interception reporting policy unit 92.

In another embodiment, the interception NE according to the present disclosure further includes a classifying unit and an adding unit. In this embodiment, the receiving unit is further configured to receive user plane data sent from the interception target or to be forwarded to the interception target. The classifying unit is configured to classify the user plane data received by the receiving unit according to traffic flows based on service feature information. The adding unit is configured to add a service associated identifier to the user plane data classified by the classifying unit, in which the service associated identifier is configured to identify the traffic flow of the user plane data. The sending unit reports the user plane data with the service associated identifier added by the adding unit.

In still another embodiment, the interception NE according to the present disclosure further includes a priority discrimination unit configured to discriminate priorities of interception targets. When congestion occurs in an interception reporting path, the sending unit reports the user plane data of an interception target with a high interception priority.

In still another embodiment, the interception NE according to the present disclosure further includes an interception significance level dividing unit, configured to divide interception significance levels for interception targets. When congestion occurs in an interception reporting path, the sending unit preferentially reports the user plane data of service sessions with high interception significance levels of the interception targets.

In still another embodiment, the interception NE according to the present disclosure further includes an interception target class configuration unit, configured to configure a service session type for being reported to an interception center for a class of the interception target. The sending unit reports the user plane data of the service session type configured for the class of the interception target according to the class of the interception target.

In still another embodiment, the interception NE according to the present disclosure further includes a service session condition matching unit, configured to designate a service session matching condition for an interception target. The sending unit only reports the user plane data of the service sessions satisfying the matching condition of the interception target.

Through the interception NE according to the embodiment of the present disclosure, according to the interception reporting policy, the user plane data of the corresponding service sessions of the interception targets satisfying the interception reporting policy is reported to the interception center, so as to reduce the reporting flow of the user plane data of some insignificant interception targets or insignificant service sessions, thereby lowering a design cost and a running cost of an interception system.

Through the interception method and the interception NE according to the exemplary embodiments of the present disclosure, according to the interception reporting policy, the user plane data of the corresponding service sessions of the interception targets satisfying the interception reporting policy is reported to the interception center, so as to reduce the reporting flow of the user plane data of some insignificant interception targets or insignificant service sessions, thereby lowering the design cost and the running cost of an interception system.

Currently, a public communication network is divided into a circuit switched domain and a packet switched domain. The conventional circuit switched domain mainly bears the voice, and the newly emerged packet switched domain bears the packet switched Internet Protocol (IP) services, for example, IP access, multimedia short message, and video on demand. According to different access network techniques, the packet switched domain is further divided into two modes, that is, fixed access and mobile access. The fixed access is the so-called broadband access, and a wireless local area network (WLAN) also belongs to the fixed access. The mobile access is the packet access provided by a mobile communication network. Due to the advantages in cost, flexibility, and other aspects, the packet switched domain network has become a future trend of the public communication network, and the circuit switched domain will gradually disappear. Accordingly, the services originally borne on the circuit switched domain network, for example, the voice service and short message service, will be migrated to the packet switched domain.

Therefore, in the current packet switched network, when the interception user plane data is reported to the interception center, if all the user plane data of the user is reported to the interception center as in the prior art, the interception center needs to analyze all the data packets, and try to restore the original service information.

The services of the packet switched domain, particularly the services on Internet, are of various types. Different services have different coding formats, signaling processes, encryption algorithms, and other features. The interception center analyzes from an IP layer under a situation of totally unknowing about the services used by the interception users, so that technical difficulties and an operation amount in the analysis are rather large. Furthermore, the services possibly cannot be restored due to the insufficient information, thereby increasing an implementation complexity and performance requirements for the interception center device. In addition, in certain packet switched domain network, in order to provide different quality of service (QoS) for different classes of services, a plurality of bearers is set up between the terminals and the public data network, so as to converge a plurality of user data flows with similar QoS requirements to be transmitted on one bearer. For example, the terminals are connected to the service network of the operator through one bearer, and meanwhile visit websites, send multimedia short messages, and send/receive E-mails through the bearer. Therefore, even if the user plane data of the interception targets after being classified is reported to the interception center according to granularities of the bearers, the interception center still needs to perform traffic classification on the user interface data based on the services, and then performs the subsequent analyzing process.

As an IP multimedia subsystem (IMS) domain is introduced, the telecommunication operators begin to deploy their services on the packet switched domain, for example, packet voice services. For the packet services controlled by the operators themselves, the network device can discriminate the classification features of different traffic flows, coding formats used by the traffic flows, and other information. Therefore, for the services controlled by the operators, if the user packets are organized in the form of traffic flows, then reported to the interception center, and the interception center is enabled to be associated with the coding formats corresponding to the traffic flows and other information, that can be helpful for lowering the difficulty of restoring the services by the interception center.

For the above situation, in an embodiment, the present disclosure provides an interception method, in which an interception center does not need to perform traffic classification on the reported user plane data according to the services, thereby improving a success ratio of assigning and restoring the services by the interception center, lowering the design cost and the running cost of the interception center, and lowering the complexity of restoring the services by the interception center for the services controlled by certain operators.

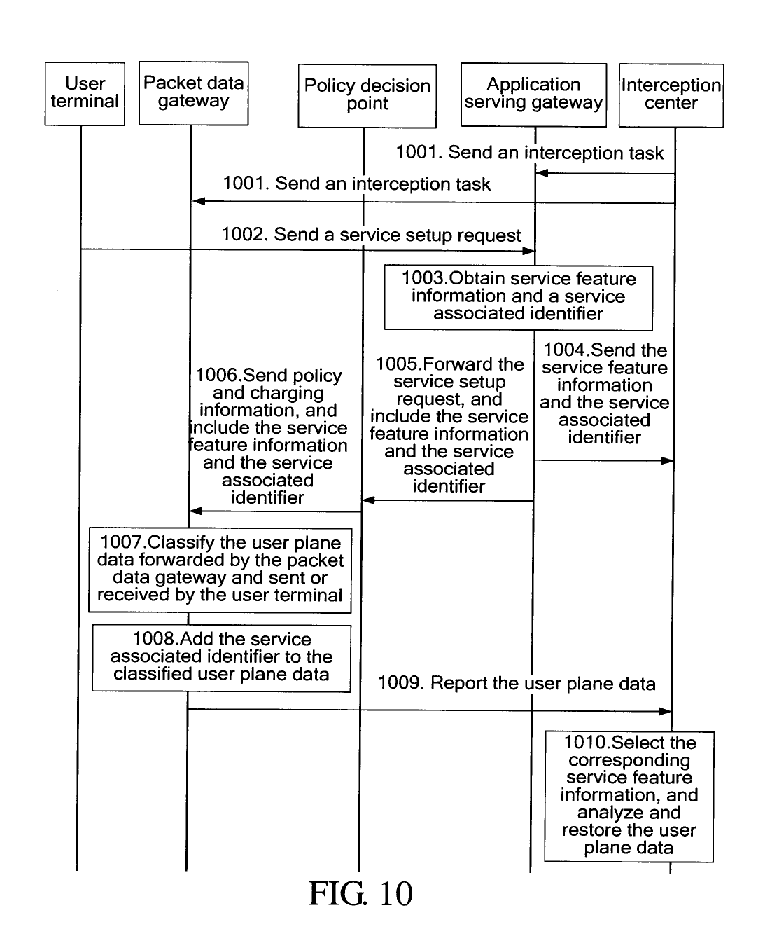

FIG. 10 is a flow chart of an interception method according to an eighth embodiment of the present disclosure. Referring to FIG. 10, the method includes the following steps.

In step 1001, an interception center delivers an interception task to an application serving gateway and a packet data gateway.

The interception center may directly deliver the interception task to the application serving gateway and the packet data gateway, and may also deliver the interception task to the application serving gateway and the packet data gateway through an interception gateway, so as to request intercepting user plane data of a certain interception target. In this embodiment, the interception target is a user terminal of a packet switched network.

In step 1002, the application serving gateway receives a service setup request of initiating a call by the user terminal.

The application serving gateway may also receive a service setup request of calling the user terminal by a peer end.

The user terminal may be a mobile terminal, and the corresponding packet data switching network is a mobile network. The user terminal may also be a fixed terminal, and the corresponding packet data switching network is a fixed network. The peer end refers to a terminal that sets up a service connection with the user terminal, which may be a mobile terminal or a fixed terminal, and may also be a File Transfer Protocol (FTP) server or a video on demand server.

The interception center may deliver the interception task to the application serving gateway or the packet data gateway at any moment, so that step 1001 and step 1002 do not have a time sequence relation. If the interception target is performing a service when the interception center delivers the interception task, the application serving gateway and the packet data gateway report the feature information of the current service of the interception target to the interception center.

In step 1003, the application serving gateway parses the service setup request, obtains service feature information, and generates a service associated identifier according to composing fields of the service associated identifier in the service feature information.

The service feature information includes a feature filtering condition corresponding to the service class, the composing fields of the service associated identifier, the coding format and encryption algorithm of the service, and other information. The feature filtering condition includes a protocol type, an address of the interception target, a protocol port number of the interception target, an address of a peer end of the interception target, or a protocol port number of the peer end of the interception target. For example, a universal service feature information description protocol is defined in RFC 4566 “Session Description Protocol (SDP)”. In the service feature information description protocol, the feature filtering condition includes the address and the port number of the interception target, the address and the port number of the peer end of the interception target, a protocol type, and a data packet direction (uplink/downlink). The feature filtering condition is allowed to use wildcard masks.

Different services have different feature information, so that the service type of the user plane data can be discriminated according to the service feature information. According to the feature filtering condition, the traffic flows may be classified.

The service associated identifier is generated according to the composing fields of the service associated identifier in the service feature information, so that the service associated identifier is corresponding to the service feature information and identifies the service type of the user plane data.

Taking an IMS domain as an example, a proxy-call session control function (P-CSCF) is equivalent to the application serving gateway, and the P-CSCF assigns an IMS charging identifier (ICID) for each service data flow, so as to uniquely identify the service data flow. One service data flow may include a plurality of media flows, for example, an audio flow and a video flow, and one media flow may further include one or more IP flows, for example, a Real Time Transport Protocol (RTP) flow and a Real Time Transport Control Protocol (RTCP) flow. In the IMS, a media flow number (Media-Component-Number) field may uniquely identify the media flow in a service data flow, an IP flow number (Flow-Number) field may uniquely identify the IP flow in a media flow, and the media flow number and the IP flow number are delivered to the packet data gateway by the P-CSCF through a policy decision point, so that a field combination of ICID+media flow number+IP flow number may globally identify an IP flow uniquely. For the service feature information, in the SDP, the coding algorithm and other feature information required when the interception center performs the analysis and restoring are defined according to the granularities of the IP flows. Therefore, the field combination of ICID+media flow number+IP flow number is taken as the service associated identifier, and the packet data gateway filters the user data packets according to the granularities of the IP flows, and adds the same service associated identifier (ICID+media flow number+IP flow number) to the user data packets belonging to the same IP flow, so that the interception center conveniently positions the feature information corresponding to the IP flow reported by the P-CSCF, so as to perform the service restoring. In practical implementation, if a length of the service associated identifier is too long, the additionally added information when the packet data gateway reports the user plane data of the interception targets to the interception center is increased, and the transmission efficiency is somewhat reduced. Thus, during the practical implementation, considering a balance of an implementation complexity of the interception center and the transmission efficiency from the packet data gateway to the interception center, it may be flexibly determined whether the packet data gateway reports the user plane data of the interception targets to the interception center according to the granularity of the service data flow, the media flow, or the IP flow. When the granularity of the service data flow is adopted, the service associated identifier may adopt the ICID. When the granularity of the media flow is adopted, the service associated identifier may adopt ICID+media flow number. When the granularity of the IP flow is adopted, the service associated identifier may adopt ICID+media flow number+IP flow number.

In the above example, the service data flow, the media flow, and the IP flow in the IMS domain are discriminated according to different granularities of the user plane service data, which are all called traffic flows in the embodiments of the present disclosure.

The service associated identifier may be formed by other self-defined characters or wildcards configured to identify the traffic flow of the user plane data. For example, “#” is defined to identify voice data, “*” is defined to identify video data. For example, “1” is defined to identify the voice data, “2” is defined to identify the video data, and “3” is defined to identify the Internet service.

In step 1004, the application serving gateway reports the service setup request to the interception center, and which includes the feature filtering condition, the coding format, the encryption algorithm, and the composing fields of the service associated identifier in the obtained service feature information.

In step 1005, the application serving gateway delivers the service setup request to a policy decision point, and which includes the feature filtering condition and the composing fields of the service associated identifier in the service feature information.

In step 1006, after making a decision according to user subscription information and local policy, the policy decision point delivers the composing fields of the service associated identifier, QoS, and charging policy information in the service feature information to the packet data gateway together.

The policy decision point decides the QoS and the charging policy of the traffic flow according to the user information subscribed by the user in advance in a policy decision database together with the feature filtering condition and QoS parameters in the service feature information delivered by the application serving gateway.

Step 1005 and step 1006 do not have a time sequence relation when being performed. Step 1005 and step 1006 may be performed at the same time, or step 1005 may be firstly performed and then step 1006 is performed, or step 1006 may be firstly performed and then step 1005 is performed.

In step 1007, the packet data gateway classifies the user plane data forwarded by itself and sent or received by the user terminals based on the traffic flows.

Specifically, the classification in step 1007 is as follows: according to the feature filtering condition in the service feature information delivered by the application serving gateway through the policy decision point, the packet data gateway classifies the user plane data of the interception target based on the traffic flows.

The packet data network assigns a bearing resource capable of ensuring the QoS to the classified user plane data, and the user terminal transmits the user plane data to the peer end through the bearing resource, and reports the corresponding charging information to a charging system.

In step 1008, the packet data network adds the service associated identifier to the classified user plane data.

The service associated identifier is added to any position of the classified user plane data.

In step 1009, the packet data gateway reports the user plane data added with the service associated identifier to the interception center.

In step 1010, the interception center selects the corresponding service feature information according to the service associated identifier of the user plane data, and analyzes and restores the user plane data.

The service associated identifier is generated according to the composing fields of the service associated identifier in the service feature information. Thus, according to the service associated identifier, the corresponding service feature information is selected as the feature information for analyzing and restoring the user plane data.

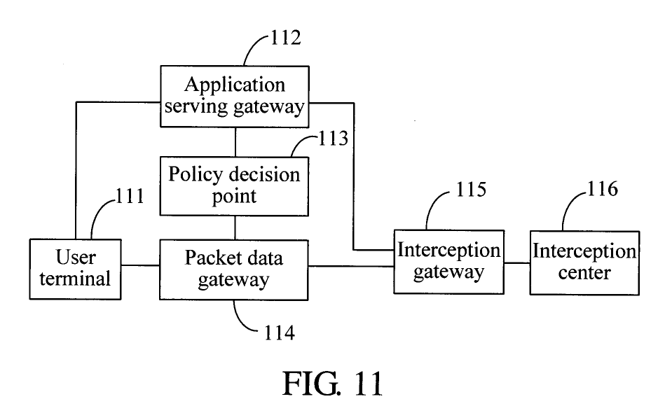

FIG. 11 is a schematic principle view of an interception system according to another embodiment of the present disclosure.

Referring to FIG. 11, the interception system includes a user terminal 111, an application serving gateway 112, a policy decision point 113, a packet data gateway 114, an interception gateway 115, and an interception center 116.

In this embodiment, the user terminal 111 serves as an interception target, and user plane data sent or received by the user terminal 111 is intercepted. The interception center 116 respectively delivers an interception task of intercepting the user terminal 111 to the packet data gateway 114 and the application serving gateway 112 through the interception gateway 115. The application serving gateway 112 parses a service setup request of initiating a call by the user terminal 111 or calling the user terminal 111, obtains service feature information, and provides the service feature information of the user plane data to the policy decision point 113 and the interception gateway 115. After making a decision according to user subscription information, the policy decision point 113 delivers policy and charging information to the packet data gateway 114, and the policy and charging information includes the service feature information. The interception gateway 115 forwards the service feature information to the interception center 116. The packet data gateway 114 classifies the user plane data forwarded by itself and sent or received by the user terminal 111 based on traffic flows according to the service feature information, adds a service associated identifier, and then reports the user plane data to the interception center 116 through the interception gateway 115. The interception center 116 selects the corresponding service feature information according to the service associated identifier of the user plane data, and analyzes and restores the user plane data.

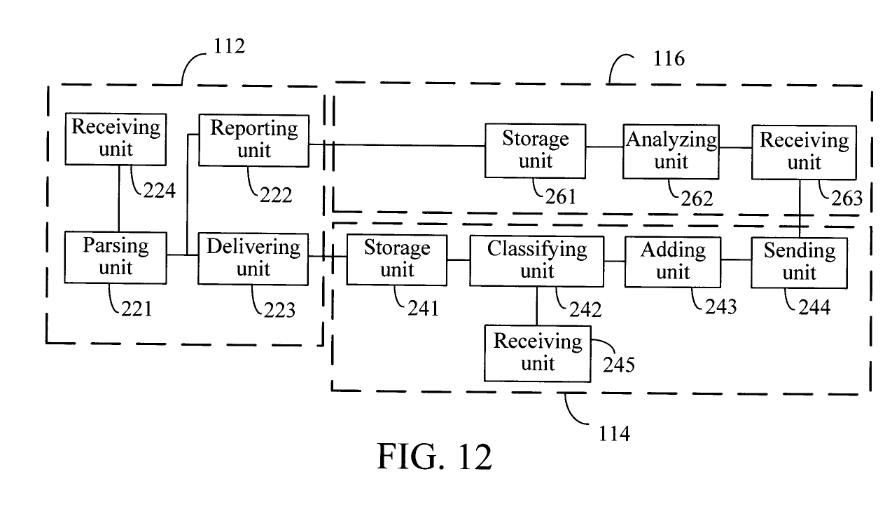

FIG. 12 is a structural view of an interception system according to still another embodiment of the present disclosure.

Referring to FIG. 12, the application serving gateway 112 includes a parsing unit 221, a reporting unit 222, a delivering unit 223, and a receiving unit 224.

The receiving unit 224 is configured to receive a service setup request of initiating a call by an interception target or calling the interception target.

The parsing unit 221 is configured to parse the service setup request received by the receiving unit 224, obtain service feature information, and generate a service associated identifier according to composing fields of the service associated identifier in the service feature information.

The service feature information includes a feature filtering condition corresponding to a service class, the composing fields of the service associated identifier, coding format and encryption algorithm of the service, and other information. The feature filtering condition includes a protocol type, an address of the interception target, and an address of a peer end of the interception target. Different services have different feature information, so that the service types of the user plane data are discriminated according to the service feature information. According to the feature filtering condition, traffic flows may be classified. The service associated identifier is generated according to the composing fields of the service associated identifier in the service feature information, so that the service associated identifier is corresponding to the service feature information and identifies the service type of the user plane data.

The reporting unit 222 is configured to report the service setup request to the interception center, which includes the feature filtering condition, the coding format, the encryption algorithm, and the composing fields of the service associated identifier in the service feature information obtained by the parsing unit 221.

The delivering unit 223 is configured to deliver the service setup request to the packet data gateway 114, which includes the feature filtering condition and the composing fields of the service associated identifier in the service feature information obtained by the parsing unit 221.

The packet data gateway 114 includes a storage unit 241, a classifying unit 242, an adding unit 243, a sending unit 244, and a receiving unit 245.

The storage unit 241 is configured to receive the service feature information delivered by the application serving gateway 112.

The receiving unit 245 is configured to receive the user plane data sent from the interception target or to be forwarded to the interception target.

The classifying unit 242 is configured to classify the user plane data received by the receiving unit 245 according to the traffic flows based on the service feature information in the storage unit 241.

The adding unit 243 is configured to add the service associated identifier to the user plane data classified by the classifying unit 242.

The sending unit 244 is configured to report the user plane data with the service associated identifier added by the adding unit to the interception center 116.

The interception center 116 includes a storage unit 261, a receiving unit 263, and an analyzing unit 262.

The storage unit 261 is configured to receive the service feature information delivered by the application serving gateway 112.

The receiving unit 263 is configured to receive the user plane data added with the service associated identifier sent from the packet data gateway 114.

The analyzing unit 262 is configured to select the corresponding service feature information according to the service associated identifier of the user plane data received by the receiving unit 263, and analyze and restore the user plane data.

Through the interception method, the interception system, the packet data gateway, and the interception center according to the exemplary embodiments of the present disclosure, the packet data gateway classifies the user plane data of the interception targets based on the traffic flows, adds the service associated identifier, and reports the user plane data to the interception center. The interception center selects the corresponding service feature information according to the service associated identifier of the user plane data, and analyzes and restores the user plane data. Therefore, the interception center does not need to perform the traffic classification on the user plane data based on the services, thereby lowering the design cost and the running cost of the interception center.

When any one of the first to seventh embodiments of the interception method according to the present disclosure is combined with the eighth embodiment of the interception method of the present disclosure, the flow of the reported user plane data during the interception process is further lowered, and the interception center does not need to perform the traffic classification on the reported user plane data based on the services, thereby lowering the design cost and the running cost of the interception system, and further reducing the complexity for the interception center to restore the service controlled by certain operator.

The interception method and the interception NE of the present disclosure are described in detail above. The principle and implementation of the present disclosure are described herein through specific examples. The description about the embodiments of the present disclosure is merely provided to facilitate the understanding of the present disclosure. Persons of ordinary skill in the art can make variations and modifications to the present disclosure in terms of the specific implementations and application scope according to the ideas of the present disclosure. Therefore, the specification shall not be construed as limitations to the present disclosure.

What is claimed is:

1. An interception method, comprising:
intercepting, by an interception network element (NE), an interception target, after receiving an interception task; and
reporting, by the interception NE, user plane data of a corresponding service session of the interception target satisfying an interception reporting policy according to the received interception task and the interception reporting policy.

2. The interception method according to claim 1, wherein the interception reporting policy is selected from the group consisting of:
designating interception priorities of interception targets, and reporting, by the interception NE, the user plane data of an interception target with a high interception priority when congestion occurs in an interception reporting path;
designating interception priorities of interception targets and configuring interception significance levels of different types of service sessions, and reporting, by the interception NE, preferentially the user plane data of an interception target with a high interception priority, and the user plane data of high-significance-level service sessions of an interception target with a low interception priority when congestion occurs in an interception reporting path;
reporting, by the interception NE, the user plane data of service sessions satisfying a service session matching condition when the service session matching condition of an interception target is designated by an interception center;
configuring interception significance levels of different types of service sessions, and reporting, by the interception NE, preferentially the user plane data of service sessions with a high significance level of an interception target when congestion occurs in an interception reporting path;
designating priorities of interception targets, configuring interception significance levels of different types of service sessions, configuring reporting policies of the user plane data of the interception targets with different priorities for different levels of congestions, and reporting, by the interception NE, the user plane data of corresponding service sessions of the interception targets according to the reporting policies of the user plane data of the interception targets with different interception priorities configured for different levels of congestions when congestion occurs in an interception reporting path;
designating priorities of interception targets, configuring interception significance levels of different types of service sessions, configuring report thresholds of the interception targets with different priorities, and reporting, by the interception NE, the user plane data of service sessions of the interception targets equal to or higher than the report thresholds; and
configuring interception target classes, configuring a service session type for being reported to an interception center for each interception target class, and reporting, by the interception NE, the user plane data of the service session type configured for the interception target class according to the interception target class.

3. The interception method according to claim 1, wherein a configuration manner of the interception reporting policy comprises at least one of:
receiving, by the interception NE, the interception task carrying the interception reporting policy associated with the interception target;
receiving, by the interception NE, the interception reporting policy associated with a type of a service session; and
configuring the interception reporting policy associated with the type of the service session on the interception NE.

4. The interception method according to claim 1, wherein
the interception task received by the interception NE is sent directly from an interception center to the interception NE; or
the interception task received by the interception NE is sent from an interception center to an interception gateway, and is forwarded to the interception NE by the interception gateway.

5. The interception method according to claim 1, wherein the interception NE directly reports the user plane data of the interception target to an interception center; or
the interception NE reports the user plane data of the interception target to an interception gateway, and the interception gateway forwards the user plane data to an interception center.

6. The interception method according to claim 1, wherein the interception NE is a packet data gateway, and the method further comprises:
classifying, by the packet data gateway, user plane data forwarded by the packet data gateway and sent or received by the interception target based on traffic flows; and
adding, by the packet data gateway, a service associated identifier to the classified user plane data, wherein the service associated identifier is configured to identify a traffic flow of the user plane data.

7. The interception method according to claim 6, further comprising:
receiving, by an application serving gateway, the interception task sent from an interception center;
parsing, by the application serving gateway, a service setup request of initiating a call by the interception target or calling the interception target according to the interception task,
obtaining service feature information, and generating the service associated identifier according to the service feature information; and
reporting, by the application serving gateway, the service setup request to the interception center, wherein the service setup request carries a part of or all composing fields in the service feature information, and delivering the service setup request to the packet data gateway, wherein the service setup request includes a part of or all the composing fields in the service feature information.

8. The interception method according to claim 7, wherein generating, by the application serving gateway, the service associated identifier according to the service feature information comprises one of:
generating, by the application serving gateway, the service associated identifier by adopting an Internet Protocol (IP) multimedia subsystem (IMS) charging identifier in the service feature information;
generating, by the application serving gateway, the service associated identifier by adopting an IMS charging identifier and a media flow number together in the service feature information; and
generating, by the application serving gateway, the service associated identifier by adopting an IMS charging identifier, a media flow number, and an IP flow number together in the service feature information.

9. The interception method according to claim 7, wherein delivering, by the application serving gateway, the service setup request to the packet data gateway comprises:
delivering, by the application serving gateway, the service setup request to a policy decision point; and
delivering, by the policy decision point, the composing fields in the service feature information to the packet data gateway according to user subscription information and local policy.

10. The interception method according to claim 7, further comprising:
selecting, by the interception center, service feature information corresponding to the service associated identifier according to the service associated identifier of the user plane data; and
analyzing and restoring, by the interception center, the user plane data according to the service feature information.

11. A packet data gateway, comprising:
a receiving unit, configured to receive user plane data sent from an interception target or to be forwarded to the interception target;
a classifying unit, configured to classify the user plane data received by the receiving unit based on traffic flows according to service feature information;
an adding unit, configured to add a service associated identifier to the user plane data classified by the classifying unit, wherein the service associated identifier is configured to identify the traffic flow of the user plane data; and
a sending unit, configured to report the user plane data with the service associated identifier added by the adding unit.

12. The packet data gateway according to claim 11, further comprising:
a storage unit, configured to receive service feature information delivered by an application serving gateway.

13. An interception center, comprising:
a receiving unit, configured to receive user plane data added with a service associated identifier; and
an analyzing unit, configured to select service feature information corresponding to the service associated identifier according to the service associated identifier of the user plane data received by the receiving unit, and analyze and restore the user plane data.

14. The interception center according to claim 13, further comprising:
a storage unit, configured to store the service feature information.

15. An interception network element (NE), configured to report user plane data of an interception target, comprising:
a receiving unit, configured to receive an interception task of intercepting an interception target;
an interception reporting policy unit, configured to store interception reporting policy; and
a sending unit, configured to report user plane data of corresponding service sessions of the interception target satisfying the interception reporting policy according to the interception reporting policy in the interception reporting policy unit.

16. The interception NE according to claim 15, wherein the receiving unit is further configured to receive the user plane data sent from the interception target or to be forwarded to the interception target, and the interception NE further comprises:
a classifying unit, configured to classify the user plane data received by the receiving unit based on traffic flows according to service feature information; and
an adding unit, configured to add a service associated identifier to the user plane data classified by the classifying unit, wherein the service associated identifier is configured to identify a traffic flow of the user plane data;
wherein the sending unit is further configured to report the user plane data with the service associated identifier added by the adding unit.

17. The interception NE according to claim 15, further comprising:
a priority discrimination unit, configured to discriminate priorities of interception targets;
wherein the sending unit is further configured to report the user plane data of an interception target with a high interception priority, when congestion occurs in an interception reporting path.

18. The interception NE according to claim 15, further comprising:
an interception significance level dividing unit, configured to divide interception significance levels of interception targets;
wherein the sending unit is further configured to preferentially report the user plane data of service sessions with high interception significance levels of the interception targets, when congestion occurs in an interception reporting path.

19. The interception NE according to claim 15, further comprising:
an interception target class configuration unit, configured to configure a service session type for being reported to an interception center for each interception target class;
wherein the sending unit is further configured to report the user plane data of the service session type configured for the interception target class according to the interception target class.

20. The interception NE according to claim 15, further comprising:
a service session condition matching unit, configured to designate a service session matching condition of an interception target;
wherein the sending unit is further configured to report the user plane data of service sessions satisfying the service session matching condition of the interception target.
